(19) United States
(12) Patent Application Publication
(10) Pub. No.: US 2008/0110086 A1
(43) Pub. Date: May 15, 2008

(54) Cellular Module for Holding Live Plants, in Particular for Placing Plants on Vertical Walls

(76) Inventor: Arnold Julia, Bordeaux (FR)

Correspondence Address: YOUNG & THOMPSON, 209 Madison Street, Suite 500, ALEXANDRIA, VA, 22314, US

(21) Appl. No.: 11/793,411

(22) PCT Filed: Dec. 22, 2005
(86) PCT No.: PCT/FR05/51133

§ 371 Date: Oct. 29, 2007

(30) Foreign Application Priority Data
Dec. 23, 2004 (FR) 04 53214

(51) Int. Cl. A01G 31/00

(52) U.S. Cl. 47/64; 47/62 R; 47/82

(57) ABSTRACT

A module suitable for the placing of plants on a natural soil substrate S or without artificial soil, whereby the substrate is oriented horizontally, with a slight or steep slope, all the way up to vertical, includes at least one front face (12), at least one rear face (14), a substrate (16) that is inserted between these at least two faces, whereby at least the front face (12) includes at least one recessed cell (18) that is obtained from the at least one front face (12), the at least one cell having a bottom (22) that is made integral with the closest rear face (14) by connecting elements (24).

This invention relates to a cellular module for holding plants, in particular applicable to placing plants on vertical walls.

The preparation and the cultivation of modular surfaces bearing plants for the purpose of their transport to receiving sites on said ready-to-use surfaces are known. Thus, the seeds, the cuttings, the plantings or the plants are introduced into substrates that are themselves contained in packets to allow their subsequent handling and are cultivated up to an adequate development stage in order to cover totally or partially said packets and are ready for use.

Actually, communities, for example, can change spring/summer floral beds for autumn/winter floral beds very quickly. In this type of cultivation, it involves only substituting plantings with others, but these plantings rest in the natural soil in which the plantings become partially rooted and from which they draw water and nutrients.

By contrast, these modular surfaces have no inherent mechanical resistance and cannot be used on natural surfaces with steep slopes and even very steep slopes and even less steep for placing plants on walls.

There exists, however, a high demand for this type of plant placement that has numerous advantages.

Actually, when a surface of a building is covered by plants, an attenuation effect of the heat is produced when it is very hot or an attenuation effect of the cold is produced when it is cold or extremely cold.

This insulation effect through the exterior is very effective when it is very warm because the plantings absorb a lot of solar energy received by said surface of a building. The evaporation also makes it possible to keep the cultivated surface at a moderate temperature.

Likewise, there is a demand for panels for the placing of plants on partitions on the inside because a plant partition makes it possible, in a surprising way, to improve the ambient acoustic conditions by greatly absorbing the basic noises.

In addition, the ambient air is also treated by the chlorophyllous mass that ensures a purification that may be of interest in and of itself. The substrate itself, for example containing activated carbon, can also absorb and trap polluting molecules that are subsequently degraded by the plants.

In addition, a plant partition allows certain decorative effects and imparts a natural ambience in the often austere working environments.

In the case of such applications, it is necessary that the proposed modules be mechanically resistant to allow their positioning directly on vertical surfaces or on bonding means that are integral with these surfaces to ensure spacing between the plant wall-facing, produced from modules, and the receiving surface.

One very significant problem is that of keeping the substrate in a thin layer despite gravity, in particular when the plants are not very rooted yet. The substrate actually has a tendency to accumulate in the lower portion of the module as soon as said module is made vertical.

In addition, it is necessary to install plantings in these modules, in the form of plantings in a clump, for example, without perforating one of the faces of the module for fear of causing the substrate to leak primarily when the latter is in powdered form.

There is also the problem of the nature of substrates, the hydration and the ability to ensure water reserves within modules, possible stiffening of the modules, the abutment of these modules to form large continuous surfaces, as well as constraints that are not resolved by the prior art and that this invention proposes to resolve.

A sine qua non condition for the production of such modules is the possibility of an industrial production to lead to acceptable costs.

In this case of industrial production, this invention calls for obtaining modules with choices for positioning cells that range from random arrangement to the arrangement that allows representations of given patterns, thanks to a suitable choice of plantings.

The invention is now described in detail from numerous embodiments that make it possible to respond to numerous applications, whereby these embodiments are the subject of accompanying graphic representations in which the different figures show:

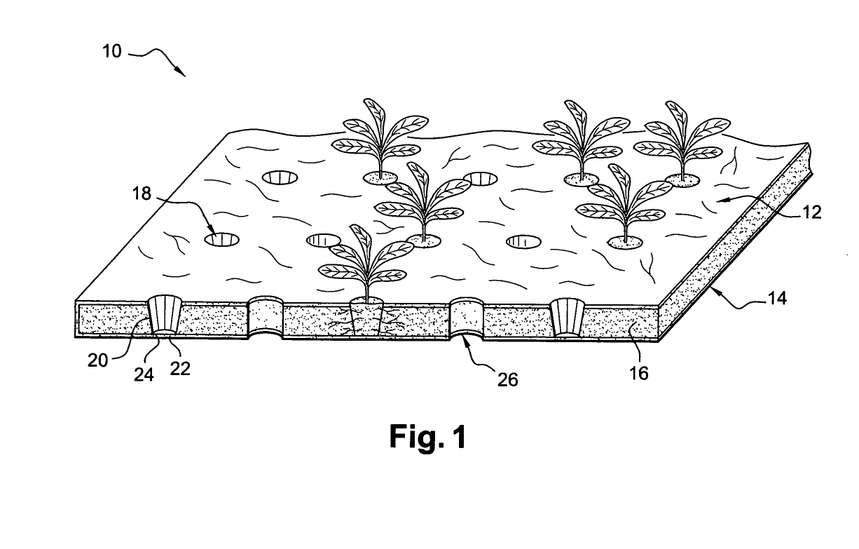

FIG. 1: A cutaway view of a basic module according to the invention,

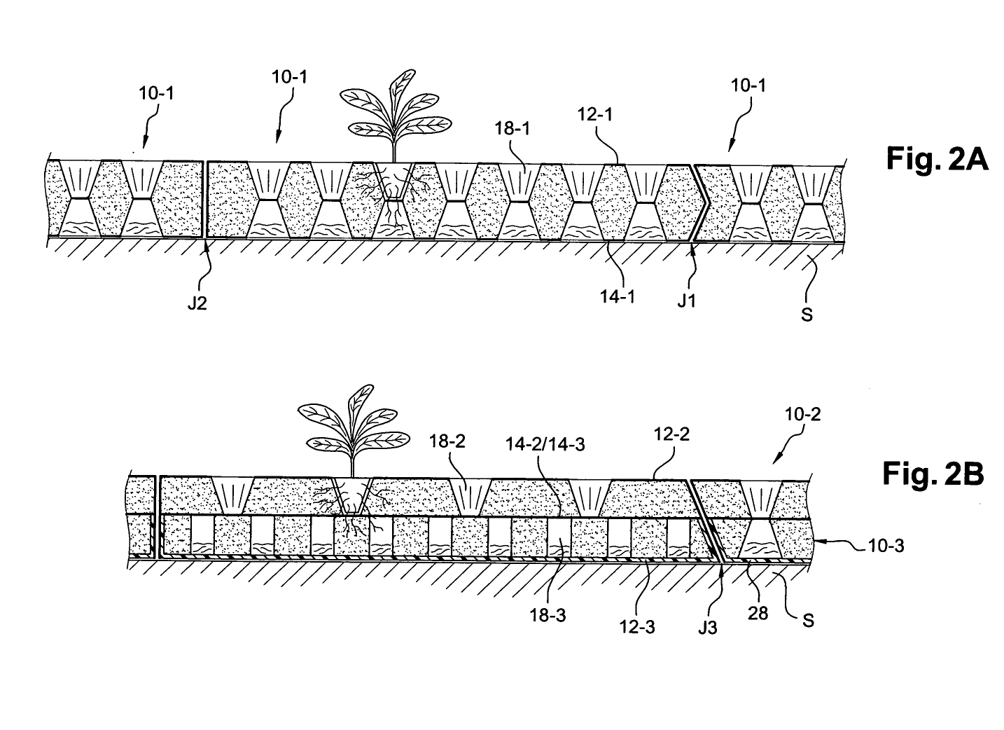

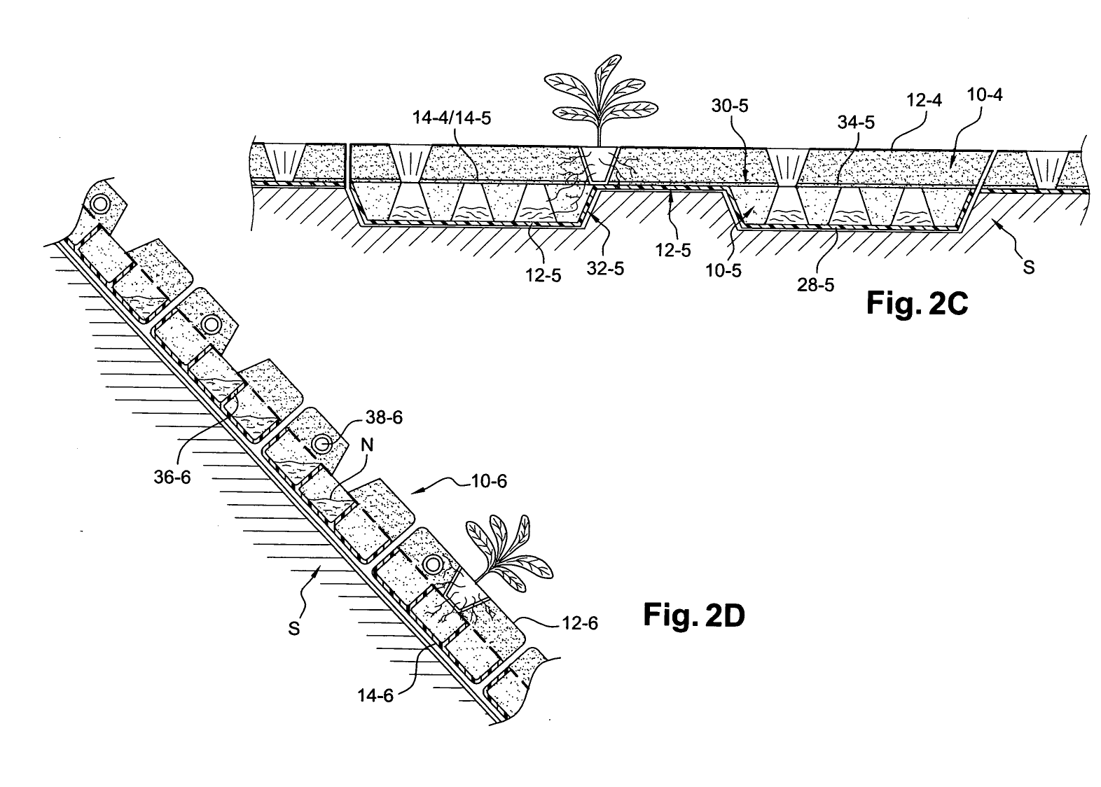

FIG. 2A: A cutaway view of a variant embodiment of a double module,

FIG. 2B: A cutaway view of a variant embodiment of the embodiment of FIG. 2A with an airtight layer,

FIG. 2C: A cutaway view of a variant embodiment of the embodiment of FIG. 2B with profile deformations,

FIG. 2D: A cutaway view of a variant embodiment of the embodiment of FIG. 2B, in which dividing partitions and a network for water and nutrient supply are provided,

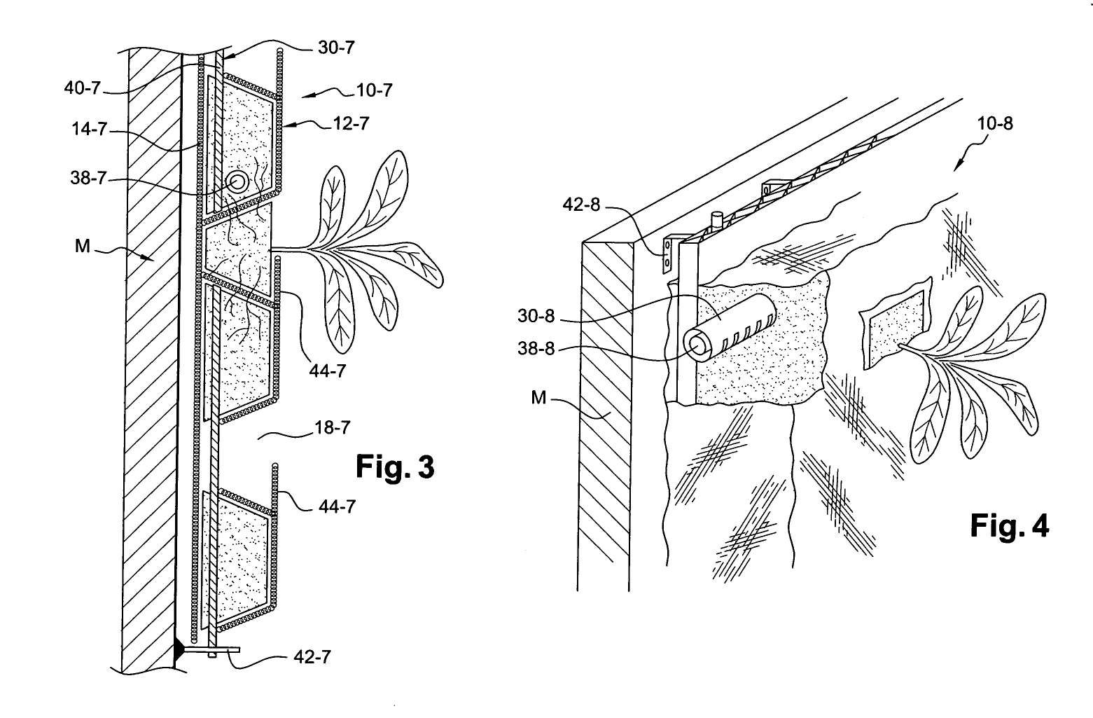

FIG. 3: Basic module according to the invention with a reinforcing structure and cell with a partial opening for a module that is made vertical,

FIG. 4: Perspective view with a partial detachment of an embodiment with a multifunctional reinforcing structure,

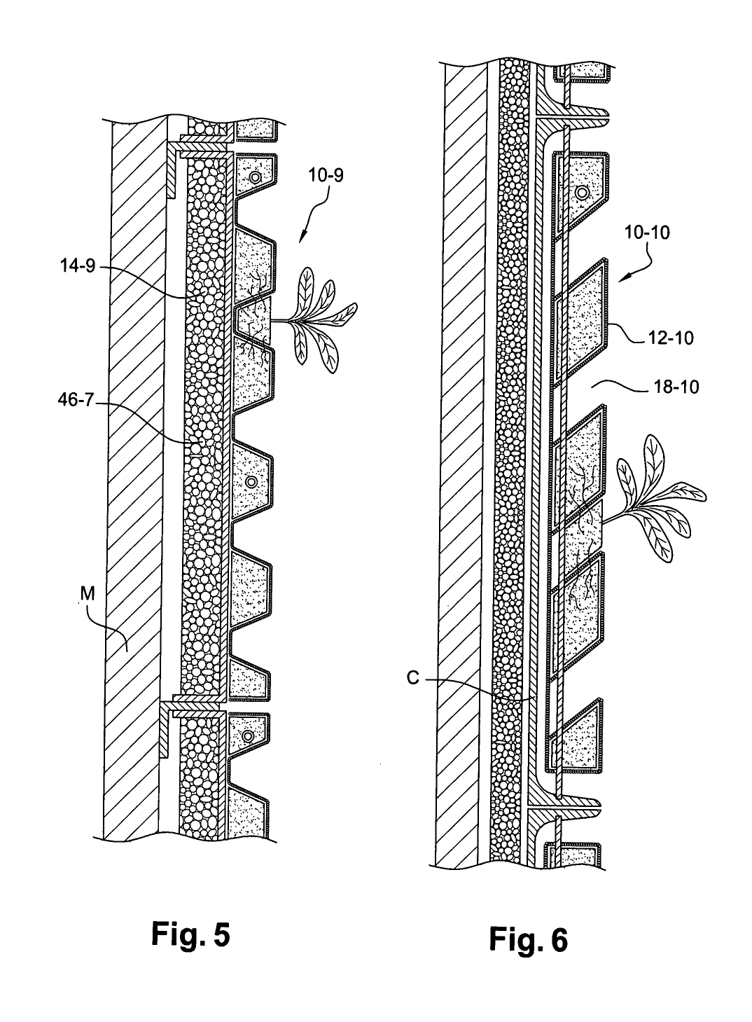

FIG. 5: A view of an embodiment of modules with a rigid rear face,

FIG. 6: a view of an embodiment of modules integrated into wall-facing boxes for construction,

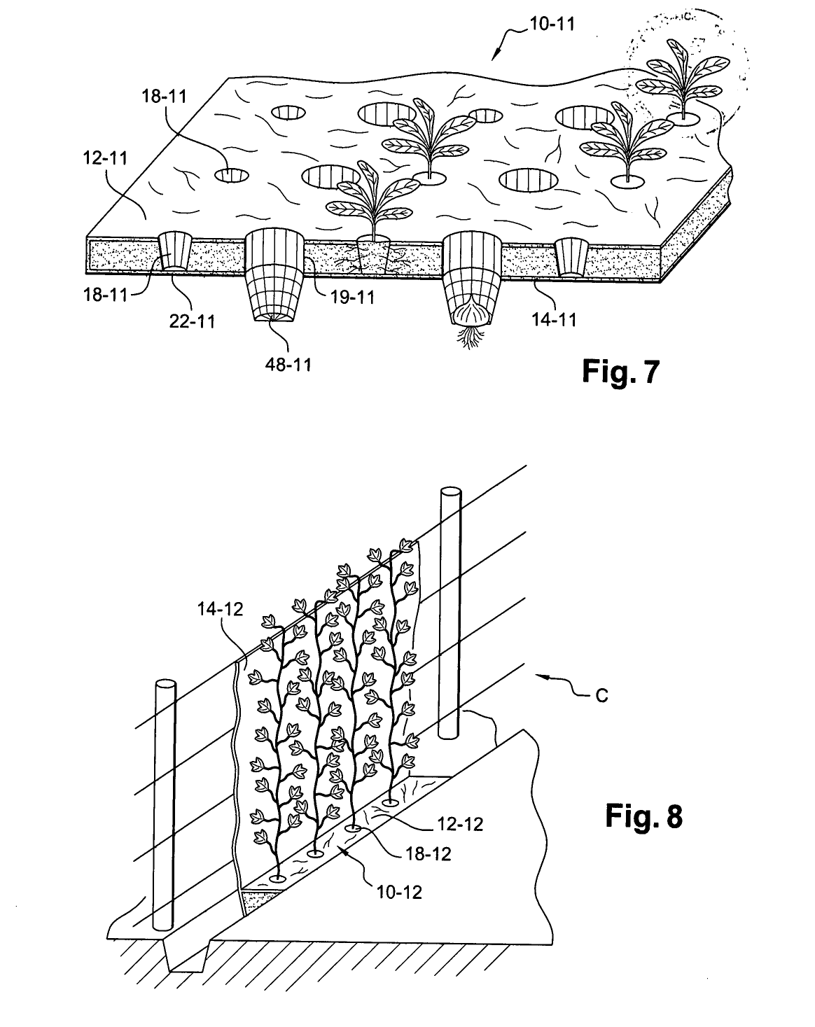

FIG. 7: A perspective view with partial detachment showing the use of a module according to the invention that comprises an improvement for the integration in particular of bulbs, and

FIG. 8, a diagrammatic view of a three-dimensional module.

In FIG. 1, a module 10 is shown diagrammatically.

This module comprises a closed volume that is delimited by a front face 12 and at least one rear face 14 with a substrate 16 that is inserted between the two faces, in this space.

The front face 12 is equipped with at least one recessed cell 18. As shown in the section of FIG. 1, this cell comprise walls 20 of any shape, with a rotational, multi-sectional or tapered profile in this case as well as a bottom 22.

In the embodiment according to the invention, this bottom 22 is made integral with the closest rear face 14 by connecting means 24. Thus, the cells by their walls ensure a bracing function and ensure holding a uniform space between the two front 12 and rear 14 faces, the rear face being the closest. This uniform space is essentially that of the depth of the cell.

The connecting means 24 are based on the nature of the materials that constitute the front 12 and rear 14 faces.

One particularly suitable embodiment consists in resorting to natural fiber such as coconut, which is coated with a bonding polymer composition, deposited by, for example, spraying. Fiber mats with dimensions of the modules to be produced are thus obtained.

The substrate 16 itself advantageously is a composition of plant and/or mineral materials. For example, this substrate can comprise plant fibers completed by seeds or spores and organic particles including nutrients, if necessary. This substrate composition is also advantageously—but not necessarily—greatly compacted to constitute panels that have a certain rigidity.

In these substrate panels, holes 26 are made, for example, that stereotypically protrude neatly with the diameters and spaces desired for the cells.

Next, a sandwich module with the substrate 16 in panel form, inserted between two pieces of mat forming the front face 12 and the rear face 14, is produced.

The module is finalized by a stage for forming cells. According to an embodiment, a hot form—in the case of coating with a thermosetting bonding polymer composition or thermosetting fibers—is positioned on the front face 12, to the right of each hole 26 that protrudes and is moved perpendicularly to this front face 12 to deform said front face in cell form until the bottom 22 of said cell that is formed comes into contact with the rear face 14 and is made integral with this rear face 14.

The fibers of the wall of the cell are stretched during this translational motion to reduce the density and subsequently to promote rooting.

It is noted that the amount of bonding polymer for coating is extremely small and allows excellent adhesion of all fibers to one another, from one face to the other and optionally with the compacted substrate panel.

This bonding polymer does not disturb the biodegradability of the substrate when the latter has the properties thereof and the selected fibers are suitable for such a natural phenomenon.

In the case of the coconut fiber, the biodegradability is very slow.

Such a module can thus accommodate different types of plantings by different methods.

The first consists in introducing grains, seeds or spores in a suitable mixture that allows the cells to fill. The flat cultivation makes it possible to reach adequate development for rooting. The module can then be readily made vertical.

Another solution consists in directly placing clumps with young plants into each cell, which allows a savings of time for rooting. Finally, it is possible to place developed plants in these cells, which allows the module to be put into service very quickly. In this case, each module can be produced on request, immediately starting from cultivated plants, furthermore.

The plants can be of any kind, hardy plants, seasonal flowering plants, or a combination of the two types within the same module.

The thus presented module can be used in zones of natural terrain with a slight slope or with a steep slope, even made vertical.

The crosspieces that are made of cells linked to the two faces make it possible to maintain the substrate whether it is in compacted form or in the form of fluid particles. These crosspieces avoid accumulation when there is a steep slope or a verticalization of the substrate in the lower portion and the barrel-shaping of each module.

The module that was described opposite FIG. 1 is the basic module, but it is possible to improve this arrangement by taking on essential characteristics and by providing complementary elements based on applications.

A first improvement is illustrated by FIG. 2A that describes a module with symmetry so as to ensure drainage, in particular for applications on synthetic substrates S, roofing, concrete soil, resin substrate with a 3D profile, for example.

In this case, it may be advantageous to provide drainage as well as an abutment of several modules that make it possible to cover a significant surface area that is larger than the surface area of a single module.

Actually, if the joint planes between two plates allow light to pass, seeds may get dumped, primarily in the open air, and poor grasses may develop.

The module of FIG. 2A is a symmetrical module 10-1.

Cells are made in the two front 12-1 and rear 14-1 faces, following the same distribution, although these cells are combined by their bottoms that originate from two opposite surfaces, essentially in a plane that is located at mid-thickness of the module.

It is noted that when the module is positioned on a flat substrate by its lower face, the cells are returned with the opening toward said flat substrate. Actually, the water does not necessarily stagnate in the substrate that is located in the top portion and the plants are rooted in the moist substrate but not necessarily in the water. This prevents the asphyxia of the plant by the roots and rot.

The amount of substrate that is available for the plants is also increased.

Conversely, in the case of dryness, the water can be provided in a large amount, at one time, and it accumulates in order to be restored by capillary action, as in a water reserve tank when the layer 14-1 is partially sealed.

In this figure, the particular geometry of the peripheral edges of the module at the junction J1 that are V-shaped so as to produce a baffle by abutment of two modules contrary to the junction J2 , which is straight, is noted.

In FIG. 2B, an arrangement with a double module 10-2 and 10-3 is shown. In this double module, two front faces 12-2 and 12-3 and one common rear face 14-2/14-3 are provided.

The cells are provided from two front faces to the common rear face. The cells are placed in a not necessarily opposite way. An additional element, namely an airtight film 28 added to the second front face 12-3 is noted. This airtight film is therefore found resting on the substrate S on which the double module is placed.

This film, when it is added to the second module 10-3 and projects beyond the periphery so as to essentially ascend to the thickness of this second module, generates a buffering effect on the flows and the evacuations of the rain waters in particular in the case of the placing of plants on roofing.

The particular beveled arrangement of the junction J3 is noted in FIG. 2B so as to avoid there also the penetration of light into the intermodular space. In this arrangement, it is possible for water to accumulate in the lower module, more particularly in the cells of the second module that ensure a water reserve.

The substrate of the second module is actually subjected by the effect of gravity to a greater pressure and is wetter than the substrate of the first module above, but the phenomenon of capillary action ensures a regular and suitable diffusion of the water of the second module toward the first.

In FIG. 2C, an embodiment of a special double module 10-4 and 10-5 is shown in this sense that it comprises, on the one hand, a reinforcement 30-5 that is integrated in the first module and deformations 32-5 that allow it to conform to the profile of the substrate S. An airtight film 28-5 in the lower portion is also provided as in the preceding embodiment.

The reinforcement 30-5 is in this case made from a trellis 34-5.

The basic arrangement with the cells that ensure the crosspiece role is thus found, whereby the reinforcement makes it possible to impart to the module a better rigidity in the plane and authorizes in particular the stowing on the substrate S, specifically the roofing.

As for the deformations 32-5, they are made like the cells and are obtained by deformation, whereby the second front face 12-5 then comes into contact with the common rear face 14-4/14-5.

In the case of an embodiment of modules 10-6 that are designed to be used for applications for substrates S with a steep slope such as a roof, FIG. 2D shows a section of such a module.

In this FIG. 2D, the modules are identical to those of the embodiment that is shown in FIG. 2C.

In contrast, so as to make it possible to store the water that is regularly distributed under each module, dividing partitions 36-6 are provided. These uniformly distributed partitions ensure that water is retained for a given volume that corresponds to a level N that passes at a maximum via the horizontal line that passes through the top of the partition.

So as to allow hydration and a supply of nutrients, if necessary, there may be provided a network 38-6 of supply ducts, ducts that can be flexible or rigid according to whether the modules are rolled for transport, for example, or whether the modules remain flat and are handled as will be explained further on in the description.

Such an application is in particular that of the placing of plants on roofing whose modules remain in place for several years.

In the case of making modules vertical according to the invention, the improvements are provided so as to allow a better implementation.

A first improvement is shown in FIG. 3. This module 10-7 comprises reinforcements 30-7 with stiffeners 40-7 that are biodegradable, such as bamboo or rods made of plastic or metal material for durable plant wall-facing. These stiffeners 40-7 may protrude on both sides of each module 10-7 so that these protruding ends can work with hooking means 42-7, themselves integral with the surface, in this case a wall M, designed to accommodate the plant wall-facing.

It is noted that the cells are made in the same way as for the basic module and connect the two front 12-7 and rear 14-7 faces.

It is also noted in this embodiment that each cell comprises an improvement in the form of holding means 44-7. In the simple and preferred embodiment, these holding means 44-7 are made of the same material as the front face 12-7 and come in the form of a partial sealing of the cell in question.

These partial sealings are oriented in the lower portion when the module is erected vertically. This imposes a direction in which the module is set up.

As shown, it is easy to place a plant, for example in the form of a clump, in a cell, and even if the plant has not taken root, the module can be made vertical without said plant falling off.

Remaining mechanically readily in contact with the walls of the cell, the rooting is promoted by the close conjugation of the planting/cell profiles.

Such a module can be equipped, if need be, with a network 38-7 for water and nutrient supply ducts.

In a variant in FIG. 4, a module 10-8 that comprises an arrangement with a tubular reinforcement 30-8 combined with a network 38-8 of water and nutrient supply ducts is shown.

Actually, the network supply ducts of water are integrated into the tubular reinforcements, whereby these reinforcements are equipped with holes so as to dispense fluids that circulate and are delivered by the ducts.

The tubular reinforcements can be fit into one another from one module to the next to ensure continuity and to keep juxtaposed modules in the same plane.

In FIG. 5, the module 10-9 is equipped on its rear face 14-9 with an insulating rigid panel 46-7, for example made of expanded polystyrene or any other insulating material. Such a panel is made in this way when the module is designed for the production of a vertical wall-facing in front of a wall M. This arrangement is suitable for being laid on the wall or allowing a free space for air circulation to exist between the module 10-9 and said wall.

In FIG. 6, the module 10-10 comprises, on its front face 12-10, cells 18-10 that have an orientation axis that is inclined relative to the plane of said module. The cells all have the same inclination, such that when they are made vertical, the contents of the cells are retained in said cells.

In addition, the module is integrated in a box C of the type of those that constitute the modular wall-facings of building fronts, in particular metallic or synthetic.

It thus is possible to replace boxes by planted boxes that have the same dimensions and that are set up on site.

It is noted that it is possible to provide arrangements with planted boxes upon construction but also a posteriori.

It is suitable to provide advantageously the setting-up of insulating material, which is made easy by the fact that the boxes are generally placed with a setting-up interval relative to the wall that supports them.

The modules according to the invention can be used in a particular way in natural soils by resorting to another variant embodiment as shown in FIG. 7.

The module 10-11 comprises a front face 12-11 and a rear face 14-11 as well as recessed cells 18-11. In addition to this arrangement, cells 19-11 of the protruding type are provided. The protruding cells 19-11 are holes whose walls consist of the material of the faces.

The improvement consists in placing baskets 48-11, which are inserted into the cells and are retained there, in these protruding cells. Actually, the protruding cells can be tapered, for example, and the baskets also, so that a mechanical blocking is produced.

In the case where the baskets are not retained, they can be recovered subsequently by any method.

These protruding cells that are equipped with baskets are designed to accommodate bulbs. It is known that the bulbs are often withdrawn at the end of the season by professionals in particular for modifying the designs during the next bulb season without allowing the preceding bulbs to exist that would disturb the new arrangement or for reusing them the next season.

For the rest of the description, bulbs are defined as: bulbs, rhizomes, tubers or onions.

Also, the improvement provided to the module 10-11 allows the withdrawal of said module with the plants placed in the recessed cells 18-11 but also to collect the bulbs.

The bulbs are rooted in the natural terrain under the module, but even if the basket disengages from the module, it remains visible in projection relative to the soil and primarily makes it possible for the party involved to recover the bulb by simple traction.

It is noted that the different modules that are proposed and produced according to the invention make possible decorations according to unlimited possibilities. It is thus that the nature of the materials that constitute the faces can be very varied in themselves and can be embellished with surface decorations between the cells, for example granulates.

The exterior shapes of the modules can be very varied to conform to the geometry of the locations designed to accommodate them.

According to a complementary variant, the module 10-2 is suitable for producing three-dimensional configurations. The diagrammatic view is shown in FIG. 8.

The module comprises a front face 12-12 and a rear face 14-12, at least one of the two faces in this case, whereby the rear face is much longer than the front face.

The module has a parallelepipedic section, and the cells are aligned along the longitudinal axis of the parallelepiped. As is shown in FIG. 8, the module is designed to be implanted at the foot of an enclosure C, for example, and the cells contain creeping plants such as hedera helix.

The rear face is unrolled and added vertically to the height of the enclosure to form a layer for development of the vegetation that is obtained from the module itself, located at the foot.

In a practical application, it is possible to market rolled modules with greatly advanced creeping plants because during the rolling of the rear face of the module around the parallelepiped that contains the substrate, the creepers of the creeping plant are rolled also because they are generally flexible.

Advantageously, the transverse stiffeners make it possible to prevent any deformation or stressing of the plants during transport because compression forces are reapplied.

According to another variant, it is possible to produce a rolled central module such as the module 10-1 that comprises plantings while bonding laterally to this module, whereby lateral wings constituted of, for example, a trellis include stiffeners that can be deployed to increase the covered surface that is ready to receive the progression of development of the plantings.

Actually, it is sufficient to position the module and to unroll the trellises to obtain a surface that can be covered by plantings as their growth proceeds, thus obtaining a large surface area that is covered starting from a small number of plants.

Such an application is advantageous for covering large surfaces quickly, zones located in highway areas, certain park zones and public gardens.

1. Module that is suitable for the placing of plants on a natural soil substrate S or without artificial soil, whereby said substrate is oriented horizontally, with a slight or steep slope, all the way up to vertical, comprising at least one front face (12), at least one rear face (14), a substrate (16) that is inserted between these at least two faces, whereby at least the front face (12) comprises at least one recessed cell (18) that is obtained from the at least one front face (12), the at least one cell comprising a bottom (22) that is made integral with the closest rear face (14) by connecting means (24).

2. Module that is suitable for the placing of plants on a natural soil substrate S or without artificial soil, according to claim 1, wherein each cell consists of a deformation, when hot, of the front face to the rear face, and wherein the connection is made simultaneously during this operation.

3. Module that is suitable for the placing of plants on a natural soil substrate S or without artificial soil, according to claim 1, wherein the front and rear faces (12, 14) consist of fiber mats, with dimensions of the modules to be produced, and the substrate (16) itself is a composition of plant materials and/or mineral materials.

4. Module that is suitable for the placing of plants on a natural soil substrate S or without artificial soil, according to claim 3, wherein this substrate composition (16) is greatly compacted to constitute panels having a certain stiffness.

5. Module that is suitable for the placing of plants on a natural soil substrate S or without artificial soil, according to claim 3, wherein the composition of plant materials and/or mineral materials is completed by seeds and/or spores and/or grains and/or nutrients.

6. Module that is suitable for the placing of plants on a natural soil substrate S or without artificial soil, according to claim 1, wherein it comprises cells (18-1) that are made in the two front (12-1) and rear (14-1) faces, according to the same distribution in such a way that these cells are combined by their bottoms essentially in a plane that is located at mid-thickness.

7. Module that is suitable for the placing of plants on a natural soil substrate S or without artificial soil, according to claim 1, wherein it is double and comprises two front faces (12-2) and (12-3) and one common rear face (14-2/14-3), whereby the cells (18-2, 18-3) are provided from two front faces toward said common rear face.

8. Module that is suitable for the placing of plants on a natural soil substrate S or without artificial soil, according to claim 1, wherein it is double (10-4) and (10-5), a reinforcement (30-5) such as a trellis (34-5), integrated with the first module and deformations (32-5) that allow it to conform to the profile of the substrate S, as well as an airtight film (28-5) in the lower portion.

9. Module that is suitable for the placing of plants on a natural soil substrate S or without artificial soil, according to claim 8, wherein it comprises dividing partitions (36-6), whereby these partitions ensure a holding of the water and wherein it comprises a network (38-6) of supply ducts, flexible or rigid, to allow hydration and nutrient supply.

10. Module that is suitable for the placing of plants on a natural soil substrate S or without artificial soil, according to claim 1, wherein it comprises reinforcements (30-7) with stiffeners (40-7), whereby these stiffeners (40-7) protrude on both sides so that these protruding ends work with hooking means (42-7) and wherein it comprises cells (18-7) that connect the two front (12-7) and rear (14-7) faces, at least one of these cells comprising holding means (44-7), whereby these holding means (44-7) come in the form of a partial sealing of the cell (18-7) in question.

11. Module that is suitable for the placing of plants on a natural soil substrate S or without artificial soil, according to claim 1, wherein it comprises an arrangement with a tubular reinforcement (30-8) combined with a network (38-8) of supply ducts of integrated water and nutrients in said tubular reinforcement, whereby this reinforcement is equipped with holes for the purpose of dispensing the circulating fluids that are delivered by the ducts.

12. Module that is suitable for the placing of plants on a natural soil substrate S or without artificial soil, according to claim 1, wherein in particular for verticalization, it comprises on its front face (12-10) cells (18-10) that have an inclined orientation axis relative to the plane of said module, whereby these cells all have the same inclination such that during the verticalization, the contents of the cells are retained in said cells, whereby said module can be integrated in a box of a modular wall-facing of the building front.

13. Module that is suitable for the placing of plants on a natural soil substrate S, according to claim 1, wherein it comprises cells (19-11) of the protruding type, accommodating baskets (48-11) that are inserted in the cells and are held there.

14. Module that is suitable for the placing of plants on a natural soil substrate S, according to claim 1, wherein it comprises two front (12-2) and rear (14-12) faces, at least one of the two faces being much longer than the other, and whereby said module is designed to be implanted at the base of an enclosure C with the at least one long face being unrolled and added vertically to the height of the enclosure to form a layer for development of the vegetation originating from the module itself, located at the bottom.

15. Module that is suitable for the placing of plants on a natural soil substrate S, according to claim 14, wherein it comprises transverse stiffeners so as to prevent any deformation or stressing of the plants during transport by reapplication of compression forces.

16. Module that is suitable for the placing of plants on a natural soil substrate S, according to claim 14, wherein it comprises a central module with plants and lateral wings linked to said module and able to be deployed to increase the covered surface that is ready to accommodate the progression of the development of plantings.

17. Module that is suitable for the placing of plants on a natural soil substrate S or without artificial soil, according to claim 2, wherein the front and rear faces (12, 14) consist of fiber mats, with dimensions of the modules to be produced, and the substrate (16) itself is a composition of plant materials and/or mineral materials.

18. Module that is suitable for the placing of plants on a natural soil substrate S or without artificial soil, according to claim 4, wherein the composition of plant materials and/or mineral materials is completed by seeds and/or spores and/or grains and/or nutrients.

19. Module that is suitable for the placing of plants on a natural soil substrate S, according to claim 15, wherein it comprises a central module with plants and lateral wings linked to said module and able to be deployed to increase the covered surface that is ready to accommodate the progression of the development of plantings.
